(19) United States
(12) Patent Application Publication
(10) Pub. No.: US 2026/0101863 A1
(43) Pub. Date: Apr. 16, 2026

(54) BIOMASS-DERIVED POLYMER COMPOSITE ANIMAL ROOST

(71) Applicant: UT-Battelle, LLC, Oak Ridge, TN (US)

(72) Inventors: Xianhui Zhao, Knoxville, TN (US); Evin Carter, Wartburg, TN (US); Jeremy Malmstead, Knoxville, TN (US); Mary K. McCracken, Knoxville, TN (US); Oluwafemi Oyedeji, Knoxville, TN (US); Soydan Ozcan, Oak Ridge, TN (US); Alex C. Roschli, Knoxville, TN (US); Tyler C. Smith, Knoxville, TN (US); Erin G. Webb, Luttrell, TN (US); Natalie Boggess, Oak Ridge, TN (US)

(21) Appl. No.: 19/357,758

(22) Filed: Oct. 14, 2025

Related U.S. Application Data
(60) Provisional application No. 63/706,830, filed on Oct. 14, 2024.

(51) Int. Cl. A01K 1/00; A01K 31/12; B29C 64/118; B29C 64/386; B29K 67/00; B29K 105/12; B29K 311/14; B29L 22/00; B33Y 10/00; B33Y 50/00; B33Y 70/10; B33Y 80/00

(52) U.S. Cl. CPC A01K 1/00; A01K 31/12; B29C 64/118; B29C 64/386; B33Y 10/00; B33Y 50/00; B33Y 70/10; B33Y 80/00; B29K 2067/046; B29K 2105/12; B29K 2311/14; B29L 2022/00

(57) ABSTRACT

An animal roost and a method of fabricating an animal roost are provided. The method includes operating a printhead having a nozzle to deposit a first layer of material through the nozzle. The first layer is one of a plurality of iteratively deposited layers of an additive build according to a three-dimensional computer model, such that the additive build is comprised of successive layers of the deposited material. The material is a biomass-derived polymer composite. The additive build forms the animal roost and includes a body having a top end and open bottom end and including front and rear walls that together define an internal volume. The additive build further includes one or more cantilevered leaves disposed within the internal volume and extending in a downward direction from the top end towards the bottom end. The one or more leaves partition the internal volume into a plurality of roosting enclosures.

### CROSS-REFERENCE TO RELATED APPLICATIONS

This application claims the benefit of U.S. Provisional Application No. 63/706,830, filed Oct. 14, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to manufactured animal roost structures, and more particularly to artificial bat houses for roosting of bats.

### BACKGROUND OF THE INVENTION

Roughly twenty species of tree-roosting bats are currently listed under federal laws or regulations across more than fifty countries. Bat populations continue to decline due to factors such as disease and forest loss. In the United States, three species of tree-roosting bats are currently listed as Endangered under the United States Endangered Species Act, and two species of tree-roosting bats are currently Under Consideration or Proposed Endangered. In the Oak Ridge, Tennessee area, for example, these include the Indiana bat (Myotis sodalis) and the Northern long-eared bat (Myotis septentrionalis), both listed as Endangered, as well as the tricolored bat (Perimyotis subflavus), which is Proposed Endangered, and the little brown bat (Myotis lucifugus), which is currently Under Consideration for federal listing. Additional species of tree-roosting bats are present in the region and considered imperiled and protected under state regulation.

These bats hibernate in caves during the winter. During the spring and summer, the bats find spots under peeling bark or cavities previously existing in trees where they roost and/or rear their pups. For the latter, termed maternity roosts, anywhere from tens to hundreds of individual bats can occupy a single structure, which requires additional space while remaining protective from weather and predators. Most roosting sites are very dependent on old and/or dead trees as that is when cavities are normally formed in the trees and when the tree bark begins to peel away. Some trees commonly selected for roosting are white oak (Quercus alba) and shagbark hickory (Carya ovata), which produces large pieces of sloughing bark even when the tree is alive. These tree species are a common feature of mature temperate forests, where bats most often prefer to roost and that are continuing to decline owing to logging and man-made development.

Relatively young forests do not offer mature or large standing dead trees that can form cavities or crevices large enough for roosting. Young forests are also characterized by a cluttered understory that can be difficult for a bat to traverse. In these cases, artificial bat roosts become useful in the conservation of imperiled tree-roosting bats. Still, there are many considerations when creating a structure that might be used by large numbers of an imperiled species. Generally, roost sites should (1) provide adequate refuge from predators, (2) buffer against temperature and moisture extremes, (3) include textured surfaces to provide foot holds for adults and pups, (4) occur within or adjacent to suitable foraging grounds, and (5) be within reasonable dispersal distance to a hibernaculum (cave). Because maternity roosts typically harbor multiple adult females and the next generation of young, their construction and placement are arguably more important. Although bat boxes have long been available to the general public, there are few options available for broadscale conservation application. Some artificial roosting structures have been designed and constructed from various synthetic materials such as polyurethane elastomers to imitate natural roost structures in appearance. Artificial bat houses can provide a safe place for bats to roost and rear their young—if they are carefully configured and deployed with consideration of the needs of local bat populations. However, considerable limitations and concerns remain.

The most evident shortfall of existing artificial roost structures is that they do not age at the same rate as natural wooden roost structures. Under natural conditions, bats relocate maternity colonies following natural loss of roost trees. Additionally, although bats often use the same roost sites in consecutive years, well-established research suggests that roosts are less likely to be used repeatedly if the number of suitable roost sites is high. This suggests two important components of roost ecology. First, when a roost is relatively permanent and additional suitable roosts are limited, bats are likely to return to that roost in several consecutive years. Second, a bat will select a new roost when the opportunity presents itself, provided that those alternatives are not at a great distance from previous roost sites. Thus, in nature, roost locations change often enough to reduce the probability that predators learn to key in on vulnerable pups. With that change in location, “clean” roosts (e.g., free from parasites or disease) are also selected, which, logically, further ensures that sanitary conditions are maintained for rearing pups.

Furthermore, existing artificial structures can be installed on metal posts, which reduces the risk of roost failure. However, roost structures remain at elevated risk of predators and conditions that promote disease and parasites the longer they remain in place. Although some artificial structures can be moved and cleaned, this requires not only removing and cleaning the structure but moving and installing it elsewhere. This can be far more time-intensive than manufacturing new structures that can also be further customized to the new location. Wooden posts (e.g., telephone poles) are far more common than metal posts for installation of synthetic roost structures. These poles, however, age at a rate much faster than artificial, synthetic roost structures themselves, which is the reverse of the natural cues that bat use to determine when to move, such as peeling bark falling from a tree before the tree itself falls. Moreover, if many bats select a single roost structure, stochastic events (lightning strikes or predators locating it) can harm a large percentage of the local bat population. It is more preferential for the bats to reduce population densities and to move to new roosting locations at a more natural pace.

Given these considerations, a continuing need exists for the manufacturing of artificial bat roosts that are one or more of biodegradable, lightweight, and cost-effective, and that mimic natural bat roosts.

### SUMMARY OF THE INVENTION

A method of fabricating an animal roost is provided. The method includes the step of operating a printhead having a nozzle to deposit a first layer of material through the nozzle of the printhead. The first layer is one of a plurality of iteratively deposited layers of an additive build according to a three-dimensional computer model, such that the additive build is comprised of successive layers of the deposited material. The material is a biomass-derived polymer composite. The additive build includes a body having walls defining an internal volume. The additive build further includes one or more leaves within the internal volume that define a plurality of roosting enclosures therein.

In specific embodiments, the biomass-derived polymer composite includes: A) a biomass material; and B) a biopolymer that is selected from a group consisting of: i) polylactic acid (PLA); ii) polybutylene succinate (PBS); iii) polyhydroxyalkanoate (PHA); iv) polyhydroxybutyrate (PHB); and v) a mixture of two or more of i) through iv).

In particular embodiments, a content of the biomass material is in a range of from approximately 5 to 50 wt. % based on a total weight of the biomass-derived polymer composite.

In particular embodiments, the biomass material includes lignocellulosic fibers.

In certain embodiments, the biomass material is selected from a group consisting of: wood fibers, corn stover, switchgrass, hemp, jute, flax, sisal, kenaf, bagasse, bamboo, rice hull, miscanthus, wheat straw, cellulose, and seed hair.

In certain embodiments, the wood fibers are pine wood fibers.

In certain embodiments, the wood fibers have an ash content in a range of from approximately 1 to 40 wt. %.

In certain embodiments, the wood fibers have a mean particle size in a range of from approximately 90 to 850 μm.

In specific embodiments, the animal roost is a bat house.

An animal roost is also provided. The animal roost includes a body having a front wall and a rear wall that together define an internal volume. The body also has a top end and a bottom end. The body is open at the bottom end. One or more cantilevered leaves is/are disposed within the internal volume and extend in a downward direction from the top end towards the bottom end. The one or more leaves partition the internal volume into a plurality of roosting enclosures. The animal roost is formed of a biomass-derived polymer composite.

In specific embodiments, the front wall and the rear wall are curved in a direction generally perpendicular to the downward direction.

In specific embodiments, the body has a crescent-like shaped cross-section.

In specific embodiments, the animal roost further includes a shelf extending from the bottom end of the rear wall of the body at an angle to the downward direction. The shelf includes a surface defining an animal landing.

In specific embodiments, the animal roost further includes at least one air vent formed in the front wall. The air vent includes an opening in the front wall and a flap extending outwardly from the front wall in the downward direction. The flap is connected to the front wall adjacent an upper end of the opening. The flap is spaced from the front wall and shields the opening. A gap is formed between the front wall and the flap.

In specific embodiments, the body includes textured, uneven surfaces.

In specific embodiments, the biomass-derived polymer composite forming the animal roost includes: A) a biomass material; and B) a biopolymer that is selected from a group consisting of: i) polylactic acid (PLA); ii) polybutylene succinate (PBS); iii) polyhydroxyalkanoate (PHA); iv) polyhydroxybutyrate (PHB); and v) a mixture of two or more of i) through iv).

In particular embodiments, the biomass material is selected from a group consisting of: wood fibers, corn stover, switchgrass, hemp, jute, flax, sisal, kenaf, bagasse, bamboo, rice hull, miscanthus, wheat straw, cellulose, and seed hair.

In specific embodiments, the animal roost is formed by 3D printing.

In particular embodiments, the body of the animal roost includes textured, uneven surfaces defined by layers of deposited material formed by the 3D printing.

In certain embodiments, the surfaces of the body of the animal roost are undulating surfaces.

These and other features of the invention will be more fully understood and appreciated by reference to the description of the embodiments and the drawings.

### BRIEF DESCRIPTION OF THE DRAWINGS

FIG. 1 is a front perspective view of an animal roost in accordance with embodiments of the disclosure;

FIG. 2 is a bottom view of the animal roost of FIG. 1;

FIG. 3 is a lateral view of the animal roost of FIG. 1 as viewed from one side;

FIG. 4 is a lateral view of the animal roost of FIG. 1 as viewed from an opposite side;

FIG. 5 is a sectional view of the animal roost of FIG. 1;

FIG. 6 is a rear view of the animal roost of FIG. 1;

FIG. 7 is a section view of an animal roost in accordance with other embodiments of the disclosure;

FIG. 8 is a rear perspective view of the animal roost of FIG. 7;

FIG. 9 is a pictorial view of an animal roost in accordance with yet other embodiments of the disclosure;

FIG. 10 is a pictorial view of an animal roost in accordance with yet other embodiments of the disclosure; and

FIG. 11 is an environmental view of the animal roost of FIG. 1.

### DETAILED DESCRIPTION OF THE CURRENT EMBODIMENTS

The current embodiments relate to animal roost structures, a method of fabricating an animal roost, and an animal roost that is formed by the method. The animal roosts can be manufactured more easily and cost-effectively than conventional artificial animal roosts. The animal roosts are also more biodegradable than conventional artificial animal roosts, and more closely mimic natural animal roosts present in animal habitats. The animal roosts and method of manufacturing the animal roosts are described in detail below.

The method of fabricating an animal roost, and particularly a bat house for the roosting of bats, includes 3D printing of the animal roost structure using a biomass-derived polymer composite material. The animal roost is therefore fabricated by additive manufacturing. More particularly, the method includes operating a printhead of a printing system that is configured to 3D print an object. The printhead includes a nozzle through which material is passed towards a build surface on which a desired object is formed. A first layer of material is flowed through the nozzle and deposited onto the build surface (e.g., build plate) to form a first layer of an additive build that defines the desired object. In various embodiments of the printing system, the printhead is configured to move in both lateral and vertical directions relative to the build surface, or in other embodiments the printhead may only move laterally in a plane relative to the build surface while the build surface is configured to move vertically towards and away from the printhead. In either case, the printhead is further operated to iteratively deposit additional, successive layers of the material to form the additive build, such that the additive build is formed by the plurality of deposited layers of material. The layers of material are deposited by the printhead in accordance with a three-dimensional computer model of the desired object, wherein the three-dimensional computer model is digitally sliced into a plurality of layers, and the printhead is programmed or otherwise instructed to successively print each of the layers in order from the bottom layer to the top layer. As such, the printing system may be embodied in a fused deposition modeling (FDM)/fused filament fabrication (FFF) 3D printer. By way of example only, the printing system may be a 3DP WorkCenter 500 large format 3D printer from 3DPlatform or a JuggerBot 3D Tradesman P3-44 large format 3D printer from JuggerBot 3D. The printing system alternatively may be a small format 3D printer, such as, by way of example only, a MakerGear M3 3D printer from MakerGear.

In various embodiments, the biomass-derived polymer composite used by the 3D printer to fabricate the animal roost comprises both a biomass material and a biopolymer. It should be understood that the composite may also include other additives in addition to the biomass material and the biopolymer, although the biomass material and biopolymer are the primary constituents of the composite. Particularly, the content of the biomass material may be approximately 5 wt. % to 50 wt. % based on the total weight of the composite. The biopolymer may be chosen from, but is not limited to, a group of polylactic acid (PLA), polybutylene succinate (PBS), polyhydroxyalkanoate (PHA), polyhydroxybutyrate (PHB), or a mixture of two or more thereof. The biomass material may comprise, consist essentially of, or consist of lignocellulosic fibers. In various embodiments, the biomass material may be chosen from, but is not limited to, a group of wood fibers, corn stover, switchgrass, hemp, jute, flax, sisal, kenaf, bagasse, bamboo, rice hull, miscanthus, wheat straw, cellulose, seed hair, or a mixture of two or more thereof. In certain embodiments, the biomass material includes wood fibers, and particularly pine wood fibers in the form of pine sawdust. The pine wood fibers have a small size, particularly a mean particle size in a range of from approximately 90 to 850 μm, optionally in a range of from approximately 90 to 180 μm, optionally in a range of from approximately 180 to 425 μm, optionally in a range of from approximately 425 to 850 μm, optionally in a range of from approximately 90 to 425 μm, optionally less than 90 μm, optionally less than 180 μm, optionally less than 425 μm, optionally less than 850 μm. The pine wood fibers also have a high ash content, particularly an ash content in a range of from approximately 1 to 40 wt. %, optionally in a range of from approximately 2 to 40 wt. %, optionally in a range of from approximately 5 to 40 wt. %, optionally in a range of from approximately 10 to 40 wt. %, optionally in a range of from approximately 20 to 40 wt. %, optionally in a range of from approximately 25 to 40 wt. %, optionally in a range of from approximately 30 to 40 wt. %, optionally in a range of from approximately 1 to 35 wt. %, optionally in a range of from approximately 1 to 30 wt. %, optionally in a range of from approximately 1 to 25 wt. %, optionally in a range of from approximately 1 to 20 wt. %, optionally up to approximately 2 wt. %, optionally up to approximately 5 wt. %, optionally up to approximately 10 wt. %, optionally up to approximately 15 wt. %, optionally up to approximately 20 wt. %, optionally up to approximately 25 wt. %, optionally up to approximately 30 wt. %, optionally up to approximately 35 wt. %, optionally up to approximately 40 wt. %. The biomass-derived polymer composite material may be fed to the printing system in the form of pellets that are, for example, melted and extruded through the printhead, but alternatively may be delivered in the form a filament.

The printing parameters for the printing system used to fabricate the animal roost by the method vary depending on factors such as size and type of the printing system. In various embodiments, the feed rate of the biomass-derived polymer composite material in the printing system may be in a range of from approximately 5 to 50,000 mm/minute, optionally in a range of from approximately 5 to 40,000 mm/minute, optionally in a range of from approximately 5 to 30,000 mm/minute, optionally in a range of from approximately 5 to 20,000 mm/minute, optionally in a range of from approximately 5 to 10,000 mm/minute, optionally in a range of from approximately 5 to 5,000 mm/minute, optionally in a range of from approximately 5 to 4,000 mm/minute, optionally in a range of from approximately 5 to 3,000 mm/minute, optionally in a range of from approximately 100 to 3,000 mm/minute, optionally in a range of from approximately 200 to 3,000 mm/minute, optionally in a range of from approximately 500 to 3,000 mm/minute, optionally in a range of from approximately 260 to 2,600 mm/minute, optionally in a range of from approximately 100 to 50,000 mm/minute, optionally in a range of from approximately 500 to 50,000 mm/minute, optionally in a range of from approximately 1,000 to 50,000 mm/minute.

In various embodiments, the throughput of the material deposited from the printhead of the printing system may be in a range of from approximately 0.8 to 3.0 kg/hour, optionally in a range of from approximately 1.0 to 3.0 kg/hour, in a range of from approximately 1.2 to 3.0 kg/hour, in a range of from approximately 1.4 to 3.0 kg/hour, in a range of from approximately 1.6 to 3.0 kg/hour, in a range of from approximately 1.8 to 3.0 kg/hour, in a range of from approximately 2.0 to 3.0 kg/hour, in a range of from approximately 2.2 to 3.0 kg/hour, in a range of from approximately 2.4 to 3.0 kg/hour, in a range of from approximately 2.6 to 3.0 kg/hour, in a range of from approximately 2.8 to 3.0 kg/hour, in a range of from approximately 0.8 to 2.8 kg/hour, in a range of from approximately 0.8 to 2.6 kg/hour, in a range of from approximately 0.8 to 2.4 kg/hour, in a range of from approximately 0.8 to 2.2 kg/hour, in a range of from approximately 0.8 to 2.0 kg/hour, in a range of from approximately 0.8 to 1.8 kg/hour, in a range of from approximately 0.8 to 1.6 kg/hour, in a range of from approximately 0.8 to 1.4 kg/hour, in a range of from approximately 0.8 to 1.2 kg/hour, in a range of from approximately 0.8 to 1.0 kg/hour, optionally at least 0.8 kg/hour, optionally at least 1.0 kg/hour, optionally at least 1.2 kg/hour, optionally at least 1.4 kg/hour, optionally at least 1.6 kg/hour, optionally at least 1.8 kg/hour, optionally at least 2.0 kg/hour, optionally at least 2.2 kg/hour, optionally at least 2.4 kg/hour, optionally at least 2.6 kg/hour, optionally at least 2.8 kg/hour, optionally at least 3.0 kg/hour.

In various embodiments, the nozzle of the printhead has an orifice diameter in a range of from approximately 1 to 75 mm, optionally in a range of from approximately 1 to 50 mm, optionally in a range of from approximately 1 to 25 mm, optionally in a range of from approximately 1 to 20 mm, optionally in a range of from approximately 1 to 15 mm, optionally in a range of from approximately 1 to 10 mm, optionally in a range of from approximately 3 to 75 mm, optionally in a range of from approximately 3 to 60 mm, optionally in a range of from approximately 3 to 50 mm, optionally in a range of from approximately 3 to 40 mm, optionally in a range of from approximately 3 to 35 mm, optionally in a range of from approximately 3 to 30 mm, optionally in a range of from approximately 3 to 25 mm, optionally in a range of from approximately 3 to 20 mm, optionally in a range of from approximately 3 to 10 mm, optionally in a range of from approximately 3 to 8 mm, optionally in a range of from approximately 3 to 6 mm, optionally at least 3 mm, optionally at least 5 mm, optionally at least 8 mm, optionally at least 10 mm, optionally at least 15 mm, optionally at least 20 mm, optionally at least 25 mm, optionally at least 30 mm, optionally at least 35 mm, optionally at least 40 mm, optionally at least 45 mm, optionally at least 50 mm, optionally at least 55 mm, optionally at least 60 mm, optionally at least 65 mm, optionally at least 70 mm, optionally at least 75 mm.

In various embodiments, a temperature of the nozzle of the printhead is in a range of from approximately 50 to 400° C., optionally in a range of from approximately 50 to 350° C., optionally in a range of from approximately 50 to 300° C., optionally in a range of from approximately 50 to 250° C., optionally in a range of from approximately 50 to 200° C., optionally in a range of from approximately 50 to 150° C., optionally in a range of from approximately 50 to 100° C., optionally in a range of from approximately 100 to 500° C., optionally in a range of from approximately 150 to 500° C., optionally in a range of from approximately 200 to 500° C., optionally in a range of from approximately 250 to 500° C., optionally in a range of from approximately 300 to 500° C., optionally in a range of from approximately 350 to 500° C., optionally in a range of from approximately 400 to 500° C., optionally in a range of from approximately 450 to 500° C., optionally in a range of from approximately 100 to 300° C., optionally in a range of from approximately 150 to 250° C., optionally in a range of from approximately 160 to 240° C., optionally in a range of from approximately 170 to 230° C., optionally in a range of from approximately 180 to 220° C., optionally at least 50° C., optionally at least 100° C., optionally at least 150° C., optionally at least 200° C., optionally at least 250° C., optionally at least 300° C., optionally at least 350° C., optionally at least 400° C., optionally at least 450° C., optionally at least 500° C.

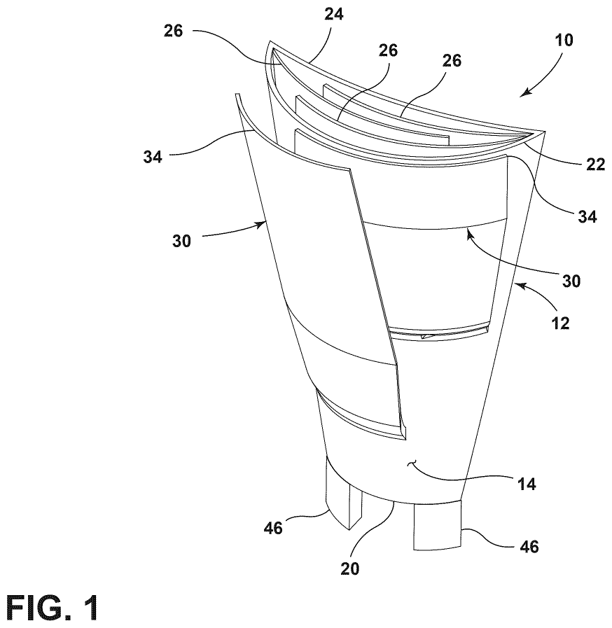

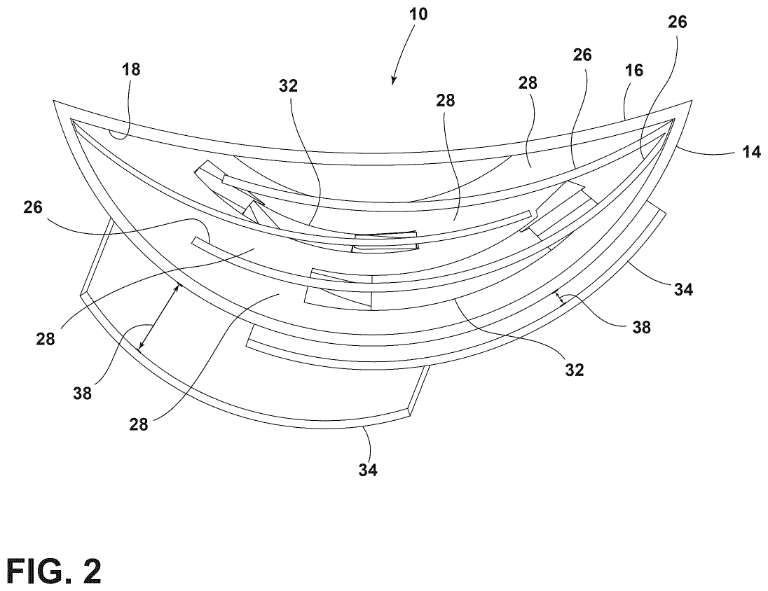

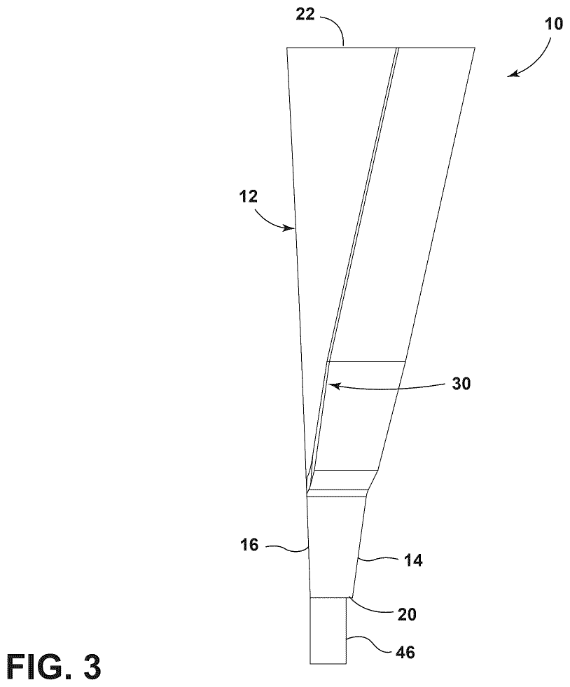

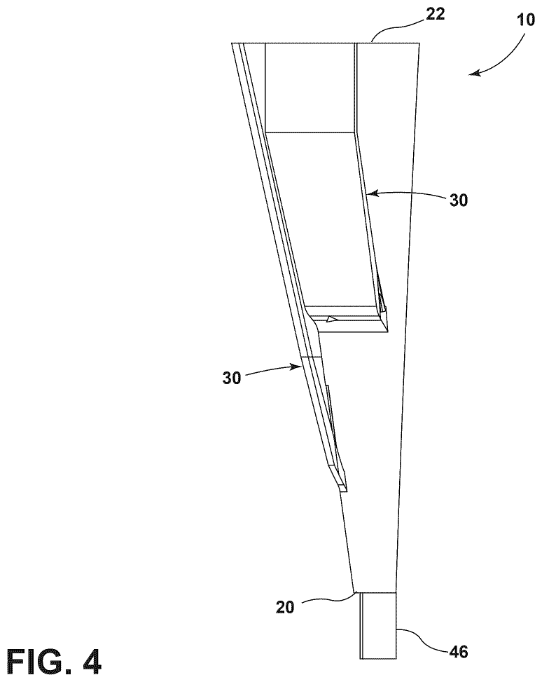

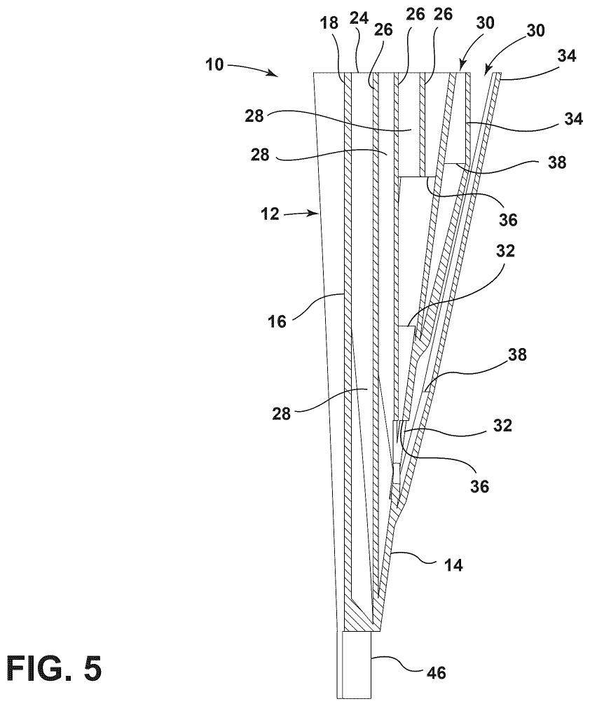

In various embodiments, the additive build is an animal roost that is particularly a bat house but which in certain alternatives may be an animal house for animals other than bats, such as, for example, birds or other wildlife. With reference now to FIGS. 1-11, wherein like numerals indicate corresponding parts throughout the several views, the animal roost 10 includes a body 12. The body 12 includes a front wall 14 and a rear wall 16 that together define an internal volume 18. The body 12 also has a top end 20 and a bottom end 22, and the body 12 is elongated and therefore longer in a vertical direction extending between the top and bottom ends 20, 22 than in a lateral direction that is perpendicular to the vertical direction. The front wall 14 and the rear wall 16 are each curved in a direction generally perpendicular to the vertical direction, each having an arcuate shape in a lateral direction The curved shape of the rear wall 16 allows the wall the match the contour of a mounting surface such as a tree or a pole. As such, the body 12 has a crescent-like shaped cross-section and/or a cross-sectional shape that is bonded by a half-ellipse and a half-circle. In FIGS. 1, 3, and 4, the animal roost 10 is turned upside down such that the bottom end 22 is at the top of the drawing and the top end 20 is at the bottom. The body 12 is open at the bottom end 22, such that the bottom end 22 defines an entrance/exit passageway 24 for an animal to enter and exit the animal roost 10. In some embodiments, the animal roost has a length of approximately 24 inches from the top end 20 to the bottom end 22, a width from one side edge to the opposite side edge of approximately 14 inches, and a passageway 24 that is approximately 4 inches at its widest point. One or more cantilevered leaves 26 are disposed within the internal volume 18 of the body 12. Each cantilevered leaf 26 extends in a downward direction (from top to bottom) from the top end 20 towards the bottom end 22. Each cantilevered leaf 26 is connected at one end to the interior of the front wall 14 at or in proximity to the top end 20 of the body 12, and each cantilevered leaf 26 is free at an opposite end that is adjacent the bottom end 22 of the body 12. By way of example, the animal roost 10 is shown with a plurality of cantilevered leaves 26. The cantilevered leaves 26 partition the internal volume 18 into a plurality of roosting enclosures 28. The cantilevered leaves 26 also may be staggered from laterally from side to side such that one leaf 26 extends from one side and stops short of the opposite side and an adjacent leaf 26 extends from the opposite side and stop short of the first side in an alternating pattern as shown best in FIGS. 1 and 2.

At least one air vent 30 is formed in the front wall 14 of the body 12. Each air vent 30 includes an opening 32 in the front wall 14 and a flap 34 extending outwardly from the front wall 14 in the downward direction. The flap 34 is connected to the front wall 14 adjacent an upper end 36 of the opening 32. The flap 34 is also spaced from the front wall 14 and overlaps the opening 32 to thereby shield the opening 32. As such, a gap 38 is formed between the front wall 14 and the flap 34. The gap 38 may have a distance between the opening 32 and the flap 34 that is in a range of approximately 0.7 to 1.0 inches. By way of example, the animal roost 10 is shown with two air vents 30. One of the air vents 30 is disposed closer to the top end 20 of the body 12 than the other air vent 30, and the two air vents 30 are offset from in each in the lateral direction. Also, one of the air vents 30 may be larger than the other air vent 30. The air vents 30 aide in regulating the temperature within the internal volume 18 of the animal roost 10 and in preventing bats from overheating when they are roosted within the animal roost 10.

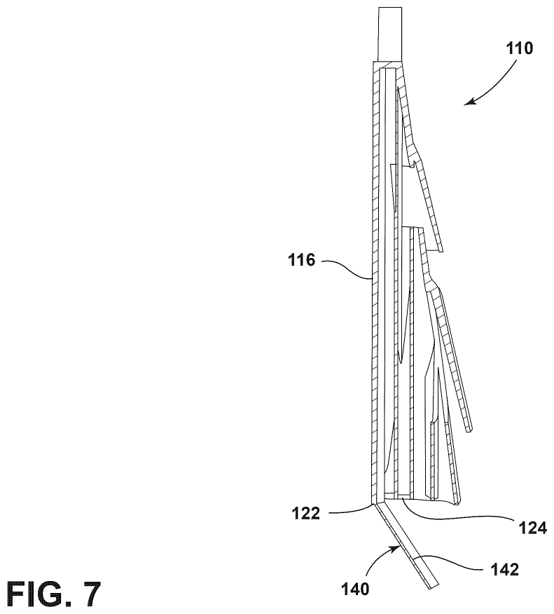

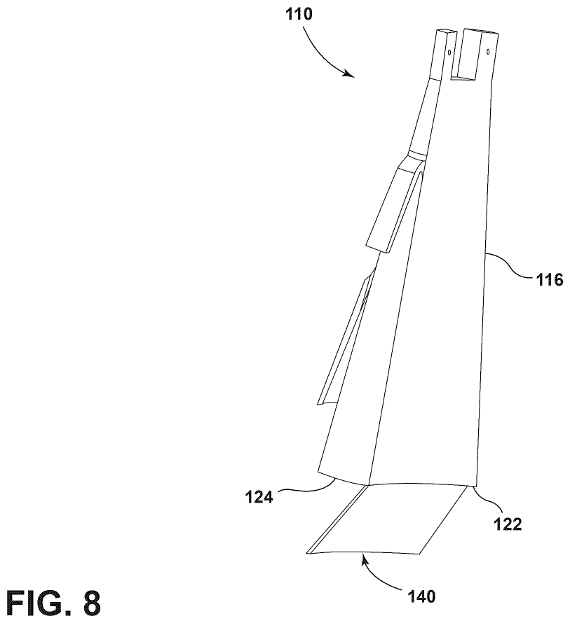

As shown in FIGS. 7 and 8, in some embodiments the animal roost 110 includes a shelf 140 extending from the bottom end 122 of the rear wall 116 of the body 112 at an angle to the downward, vertical direction. The shelf 140 has a surface that defines an animal landing 142. The animal landing 142 provides an area for an animal the land for entry into the body 112 of the animal roost 110 through the passageway 124 at the bottom end 122.

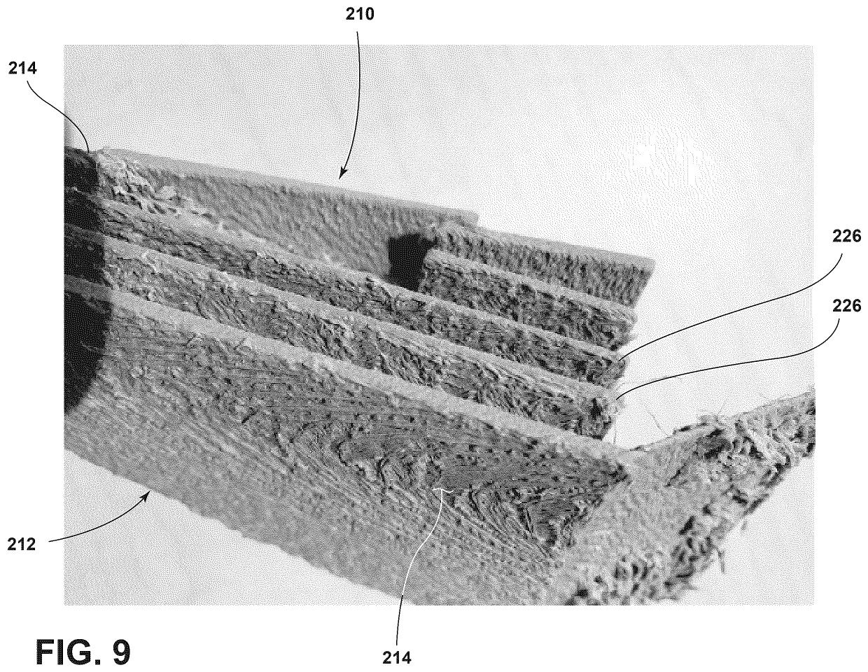

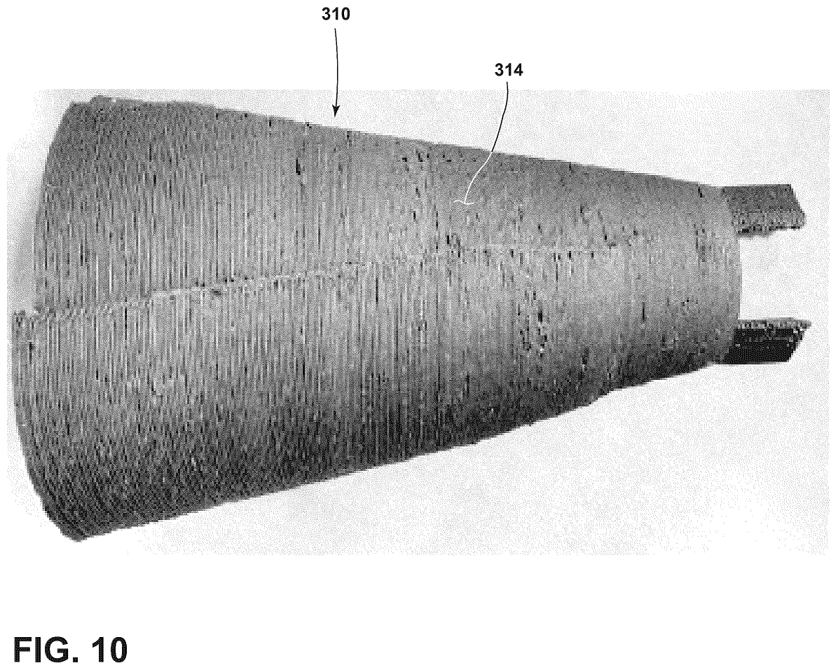

As shown in FIG. 9, in some embodiments the body 212 of the animal roost 210 includes textured, uneven surfaces 244, such as on the outer surface of the front wall 214 and/or on surfaces of the cantilevered leaves 226. For example, the three-dimensional model of the animal roost 210 may be designed so that the outer surface of the front wall 214, the surfaces of the cantilevered leaves 226, and/or all of the surfaces of the body 212 have the counters of tree bark. The tree-bark-like surface is textured and uneven, mimics the natural roosting habitat of bats, and provides a surface that is easier for bats to attach to. In other embodiments as shown in FIG. 10, the textured, uneven surfaces 344 of the animal roost 310 may be defined by layers of deposited material formed by the 3D printing material that is extruded from the printhead nozzle of the 3D printer. In these embodiments, the surfaces 344 may be undulating surfaces. In addition, the surfaces 244, 344 may be imparted with texture from the presence of the biomass material in the layers of deposited polymer composite.

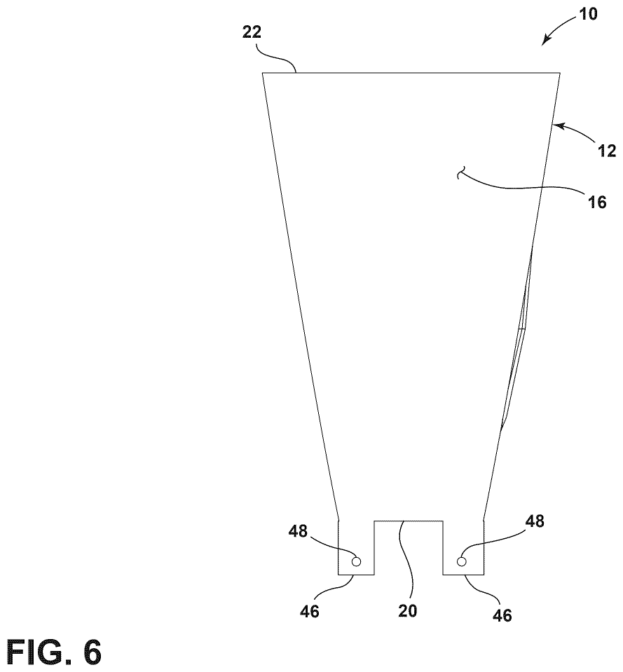

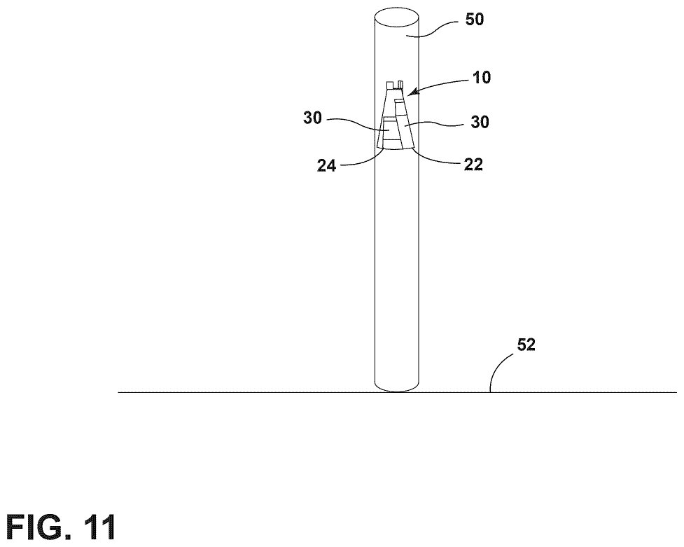

In various embodiments as shown in FIG. 6, the animal roost 10 may include one or more attachment members, such as, for example, one or more tabs 46 that extend from the top end 20 of the body 12. Each tab 46 may include an aperture 48 through which a nail, screw, bolt, or other fastener can be inserted to mount the animal roost 10 to a tree or pole that extends generally vertically from the ground 52. In use, the animal roost 10 can be, for example, mounted to a tree or pole 50 oriented with the bottom end 22 facing downward toward the ground 52 so that the passageway also faces downward as shown in FIG. 11. Animals such as bats can enter the animal roost 10 through the passageway 24 and choose one of the roosting enclosures 28 in which to roost. The air vents 30 provide for circulation of air through the internal volume 18 of the body 12 to regulate the temperature therein. The roosting enclosures 28 that are closer to the rear wall 16 and farther from the air vents 30 may then be warmer than the roosting enclosures 28 that are adjacent and/or more proximate the air vents 30. Thus, a bat may choose a roosting enclosure 28 that is at a desired temperature.

Advantageously, the animal roost 10, 110, 210, 310 is formed of the biomass-derived polymer composite material and is therefore more biodegradable than other conventional, artificial animal roost structures. Thus, the animal roost 10, 110, 210, 310 may naturally break down and decompose at a rate that is similar to the breakdown of natural bark or a tree hollow, which forces bats to relocate as they normally would to find new roost locations.

In various embodiments, the animal roost 10, 110, 210, 310 is formed by 3D printing such as described above. The animal roost 10, 110, 210, 310 thereby has an integral, one-piece construction. In other embodiments, the animal roost may be printed in more than one piece and assembled together. While the animal roost 10, 110, 210, 310 is described herein as being 3D printed, it should be understood, however, that the same or similar animal roost structures may be fabricated by methods other than 3D printing.

### EXAMPLE

The present method is further described in connection with the following laboratory example, which is intended to be non-limiting.

Computer aided design (CAD) models of the bat roost structures were generated. A small-scale prototype was produced using a desktop 3D printer via filaments. Pine/PLA composite pellets were fabricated for large-scale 3D printing demonstration by using high-ash and small-size biomass fibers that are, for example, typically marketed as low-value byproducts in the biofuel industry. A full-size bat roost structure was produced using a large-scale 3D printer via the pine/PLA pellets.

Creo Parametric 3D Modeling Software 9.0.0.0 by PTC was used to create different CAD models of the bat roost structures. Ultimaker Cura was used to slice the CAD models for printing. A MakerGear M3 printer was used to print out a small prototype of the finalized base design. Solidwork's 3D texture feature was used to make the outside layer of the CAD model appear like natural tree bark. A 3DP WorkCenter 500 3D printer and a JuggerBot 3D Tradesman P3-44 3D printer were used to print final full-size designs.

The small-scale model was printed to be about 7.5 inches by 4 inches using wood/PLA filament. The print came out well but there were too many supports in such small areas that were too difficult to get out. The supports were designed using the “normal” supports “everywhere” features in the Cura slicer software. A different approach would need to be taken for supports when printing a final, full-size bat house. Next, it was attempted to print each half of the bat house by itself so it would be easier to remove the supports. Once the supports were removed, the two halves could be glued together but these models were kept open to be able to see the inside. For these, the “tree” supports “everywhere” setting was used in Cura slicer. The supports for these prints were much easier to remove. However, these prints were much more brittle and broke easily. This may have been because the cross section was facing down during the print and the layers were building on top of each other that way, making it want to break in that direction. The previous print (the small-scale model of roost) was much more stable since the back of the roost was touching the build plate and the way it was printing in elliptical-shaped layers which makes it stronger. The last attempt tried to combine how easy it was to remove the supports in the second print and how smooth and strong the first one was. The last attempt was printed in two halves with the back of the roost facing the build plate and using the “tree” supports everywhere setting in Cura slicer. The supports took a while to work on but were mostly able to be removed. It was still a bit delicate when removing supports since there are so many layers but it wasn't as brittle as the previous prints. The entrance to the roost was also no longer blocked by support pieces which was an improvement from the previous print. All the surfaces within the layers facing up were mostly smooth with some grooves and all the surfaces facing down had a nice rough texture that should be desirable for bats to grip.

For large-scale 3D printing, approximately 239 pounds of composite pellets (20 wt % pine fibers and 80 wt % PLA) were fabricated by Techmer PM company. The pine was off-spec fiber (high ash and high fines, which do not meet biofuel feedstock specifications) from mechanical fractionation made by Idaho National Laboratory. The pine contained 2 wt. % of ash (clean pine without bark has <0.5 wt. % of ash). The PLA was a biopolymer (made from biomass, like plant starch). The pine/PLA pellets were dried at 80° C. for 8 hours prior to the 3D printing.

A first trial full-size bat house was printed with a large-scale 3D printer (3D Platform, Workcenter 500). The printing conditions were: nozzle temperature of 210° C., deposition rate of 2.75 kg/h, feed rate of 2000 mm/min, layer height of 3 mm, and nozzle size of 5 mm. The printability of the material at the beginning (approximately 80% of the printed item) was high. However, in the last 20% of the printed item, the materials became hot and started to drop. One potential reason for the dropping was that the printing speed was high for the top part of the bat house (thus there is not much time for the materials to cool within a narrow space) and the speed cannot be changed after starting the printing process due to issues with the machine control. In a second trial, a full-size bat house was printed again, at a slower speed, but a similar issue occurred. Based on these results, another 3D printer machine (JuggerBot 3D) was used, which has some additional features such as loading feed materials automatically and changing the printing speed and printing temperature at any time. A successfully 3D printed full-size (27 inch tall, 16 inch wide, weight 9.2 pounds) bat house was made using the JuggetBot 3D large-scale 3D printer. The printing conditions were: nozzle temperature of 195° C., deposition rate of 0.8 kg/h, feed rate of 2600 mm/min for initial layers and 260 mm/min for final layers, layer height of 2.5 mm, and nozzle size of 4 mm. There was no need to remove the supports for the large-scale 3D printed bat house, in contrast to the small-scale 3D printing.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of fabricating an animal roost, the method comprising:
operating a printhead having a nozzle to deposit a first layer of material through the nozzle of the printhead, the first layer being one of a plurality of iteratively deposited layers of an additive build according to a three-dimensional computer model, such that the additive build is comprised of successive layers of the deposited material;
wherein the material is a biomass-derived polymer composite;
wherein the additive build includes a body having walls defining an internal volume, and the additive build further includes one or more leaves within the internal volume that define a plurality of roosting enclosures therein.

2. The method of claim 1, wherein the biomass-derived polymer composite includes: A) a biomass material; and B) a biopolymer that is selected from a group consisting of: i) polylactic acid (PLA); ii) polybutylene succinate (PBS); iii) polyhydroxyalkanoate (PHA); iv) polyhydroxybutyrate (PHB); and v) a mixture of two or more of i) through iv).

3. The method of claim 2, wherein a content of the biomass material is in a range of from approximately 5 to 50 wt. % based on a total weight of the biomass-derived polymer composite.

4. The method of claim 2, wherein the biomass material includes lignocellulosic fibers.

5. The method of claim 4, wherein the biomass material is selected from a group consisting of:
wood fibers, corn stover, switchgrass, hemp, jute, flax, sisal, kenaf, bagasse, bamboo, rice hull, miscanthus, wheat straw, cellulose, and seed hair.

6. The method of claim 5, wherein the wood fibers are pine wood fibers.

7. The method of claim 5, wherein the wood fibers have an ash content in a range of from approximately 1 to 40 wt. %.

8. The method of claim 5, wherein the wood fibers have a mean particle size in a range of from approximately 90 to 850 μm.

9. The method of claim 1, wherein the animal roost is a bat house.

10. An animal roost comprising:
a body including a front wall and a rear wall that together define an internal volume, the body having a top end and a bottom end, the body being open at the bottom end;
one or more cantilevered leaves disposed within the internal volume and extending in a downward direction from the top end towards the bottom end, the one or more leaves partitioning the internal volume into a plurality of roosting enclosures;
wherein the animal roost is formed of a biomass-derived polymer composite.

11. The animal roost of claim 10, wherein the front wall and the rear wall are curved in a direction generally perpendicular to the downward direction.

12. The animal roost of claim 10, wherein the body has a crescent-like shaped cross-section.

13. The animal roost of claim 10, further including a shelf extending from the bottom end of the rear wall of the body at an angle to the downward direction, the shelf including a surface defining an animal landing.

14. The animal roost of claim 10, further including at least one air vent formed in the front wall, the air vent including an opening in the front wall and a flap extending outwardly from the front wall in the downward direction, the flap being connected to the front wall adjacent an upper end of the opening, the flap being spaced from the front wall and shielding the opening, wherein a gap is formed between the front wall and the flap.

15. The animal roost of claim 10, wherein the body includes textured, uneven surfaces.

16. The animal roost of claim 10, wherein the biomass-derived polymer composite includes: A) a biomass material; and B) a biopolymer that is selected from a group consisting of: i) polylactic acid (PLA); ii) polybutylene succinate (PBS); iii) polyhydroxyalkanoate (PHA); iv) polyhydroxybutyrate (PHB); and v) a mixture of two or more of i) through iv).

17. The animal roost of claim 15, wherein the biomass material is selected from a group consisting of: wood fibers, corn stover, switchgrass, hemp, jute, flax, sisal, kenaf, bagasse, bamboo, rice hull, miscanthus, wheat straw, cellulose, and seed hair.

18. The animal roost of claim 10, wherein the animal roost is formed by 3D printing.

19. The animal roost of claim 18, wherein the body includes textured, uneven surfaces defined by layers of deposited material formed by the 3D printing.

20. The animal roost of claim 19, wherein the surfaces are undulating surfaces.
